(19) United States
(12) Patent Application Publication
(10) Pub. No.: US 2002/0135194 A1
(43) Pub. Date: Sep. 26, 2002

(54) Storage for vehicles

(76) Inventor: Stefan Helmut Schwarz, Orion Township, MI (US)

Correspondence Address: Liniak, Berenato, Longacre & White, 6550 Rock Spring Drive, Ste. 240, Bethesda, MD, 20817, US

(21) Appl. No.: 09/814,769

(22) Filed: Mar. 23, 2001

(51) Int. Cl. B60R 7/06

(52) U.S. Cl. 296/37.8; 296/70

(57) ABSTRACT

A center console for a motor vehicle has a pullout drawer structure having fastenings allowing different modules to be secured within it. The modules include audio modules, especially a CD changer, and also storage trays. Open sides permit access by the driver and/or passenger when open. The drawer may be locked shut for security. A hinged tray is provided which projects from the top of the drawer when the drawer is closed.

### FIELD OF THE INVENTION

The present invention lies in the field of storage in vehicles, and more specifically to an open-sided storage structure for a motor vehicle cabin and to a motor vehicle incorporating such a structure.

### BACKGROUND OF THE INVENTION

There is an increasing demand in motor vehicle cabins for storage both of temporarily carried articles such as maps, cups and personal effects and also for permanently or semi-permanently installed articles. Such permanent or semi-permanently installed articles include entertainment devices such as CD chambers, navigational computer devices and communication devices such as mobile telephones.

Frequently the only lockable storage location is the socalled glove compartment and this is often not large enough, or not correctly shaped to store some more valuable articles.

There exists therefore a need for a relatively large storage structure which is capable of being locked and which is capable of being adapted to suit the needs of particular drivers.

### SUMMARY OF THE INVENTION

According to one aspect of the present invention there is provided an open-sided storage structure for a motor vehicle cabin, this storage structure having opposed first and second end walls and runner members secured thereto to define said open sides, said runner members being adapted to engage formations of the vehicle cabin whereby said structure is movable on said runner members between a first closed position and a second open position, said second open position allowing access by a vehicle passenger or driver.

According to a second aspect of the present invention there is provided a motor vehicle having a longitudinal axis and comprising a cabin having a driver's seat for accommodating a driver, the cabin having a front wall and an open-sided storage structure, said storage structure having a first wall, the first wall being disposed substantially transverse said axis and being secured to runner members extending substantially parallel to said axis, said runner members defining said open sides and engaging a formation of said cabin, wherein the first wall is translatable with said runner members along said longitudinal axis between a closed position where the first wall abuts a portion of said front cabin wall and an open position where the first end wall is spaced from said front cabin wall to allow access by said driver to said storage structure.

### BRIEF DESCRIPTION OF THE DRAWINGS

A preferred embodiment of the present invention will now be described with reference to the accompanying drawings in which:-

FIG. 1 shows a cut away perspective view of a portion of a vehicle cabin including a storage structure in accordance with the present invention.

FIG. 2 shows a cross-sectional view through a storage structure in accordance with the present invention and;

FIG. 3 shows various inserts capable of being used with the storage structure shown in FIGS. 1 and 2.

### DESCRIPTION OF THE PREFERRED EMBODIMENTS

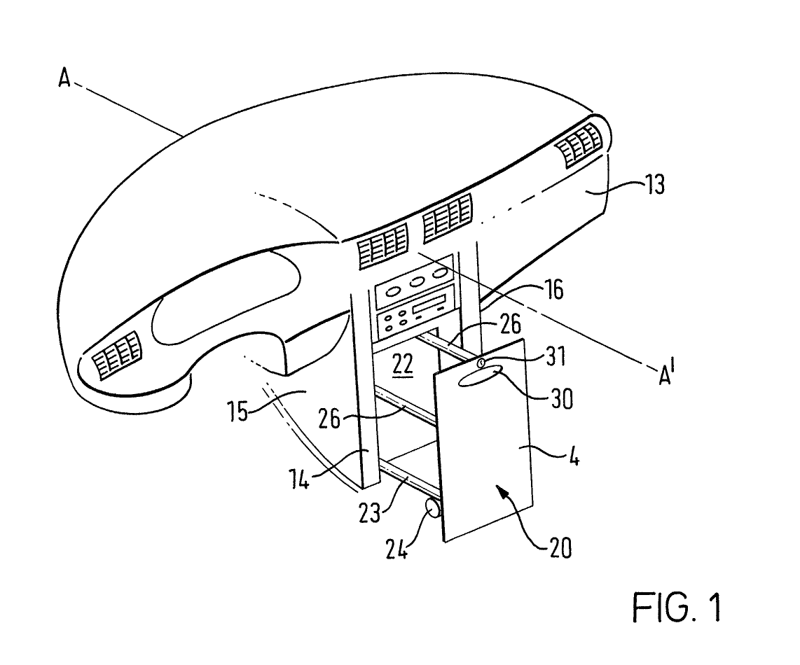

Referring first to FIG. 1, a motor vehicle has a longitudinal axis A-A′ and a cabin with a front wall. The front wall extends from the floor 10 of the vehicle (see FIG. 4) and forms a footwell 11 for the driver and another footwell 12 for the passenger. It then extends upwardly before curving round to form the fascia 13 in front of the driver and passenger, and extending between them.

Continuing to refer to FIG. 1, a housing 14 extends between the driver and passenger and has a driver's side wall 15 and a passenger's side wall 16. The walls 15 and 16 which extend from the floor generally up through the fascia define therebetween a space which houses a storage structure 20 having a front wall 21, a rear wall 22 and a pair of runner members 23 extending between the two walls 21, 22 towards the bottom thereof so as to join the two walls together. The runner is shown as being supported by a roller 24 which runs along the vehicle floor. However, the runner of the preferred embodiment engages with a counterpart projection on the inside of the walls 15, 16 of the housing, the projection carrying the runner members 23 via rollers in a manner known for supporting drawers.

A pair of support members 26 in the form of rails may be slotted into counterpart holes in the front and rear walls 21, 22, the holes being provided at a number of locations so that the support rails can be located in several different locations within the storage structure 20. The front wall 21 has a handle portion 30 for allowing a user to open or close the storage structure 20 and there is a barrel type lock 31 at the top of the front wall 21 which engages with the fascia to allow the structure to be locked in its closed position.

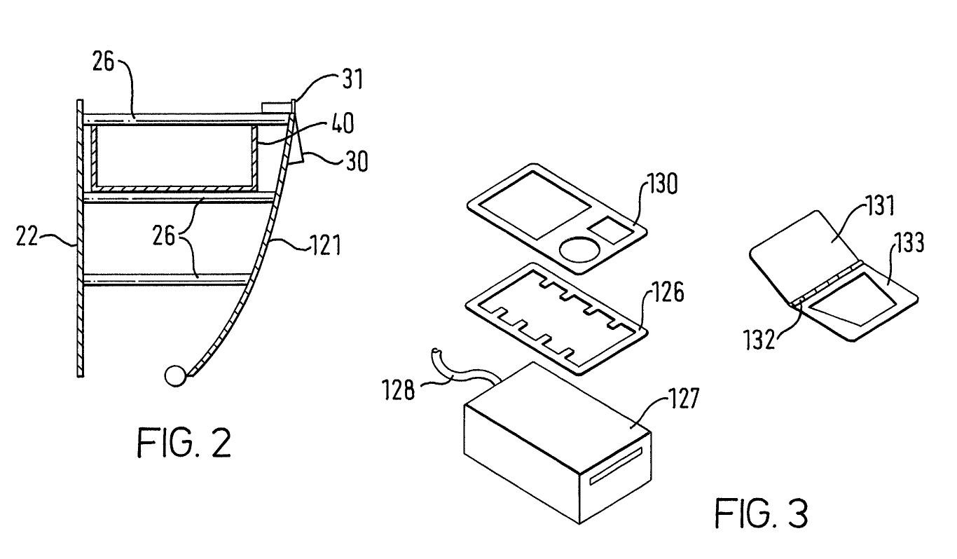

Referring now to FIG. 2 an alternative form of the support structure is shown in cross-section. In this case, the front wall 21 which is shown in FIG. 1 as being substantially planar and parallel to the back wall 22 is replaced by a curved wall 121 which is shaped such that the lower part of the support structure extends less far than the upper part. In the device of FIG. 2 a bin 40 is shown engaged on support rails 26.

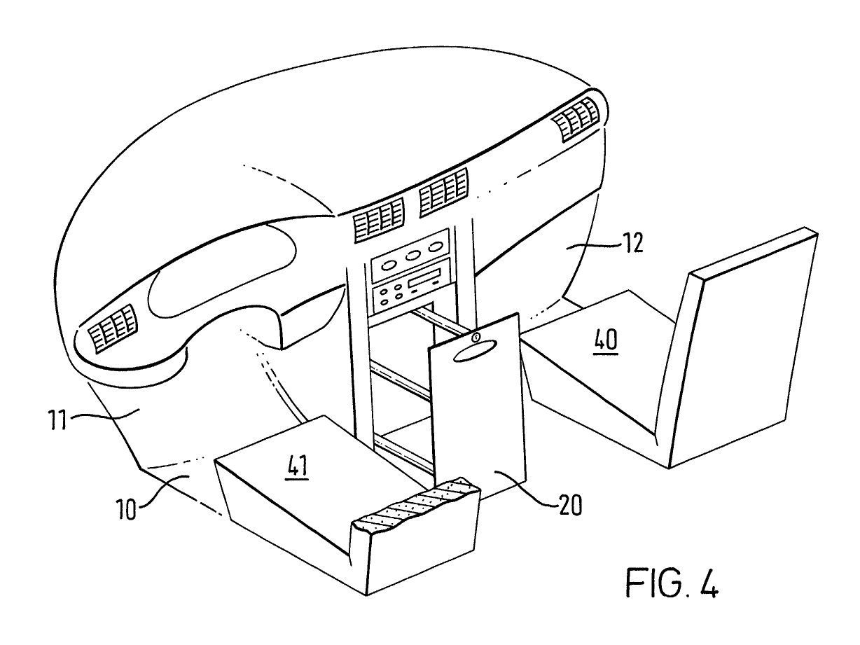

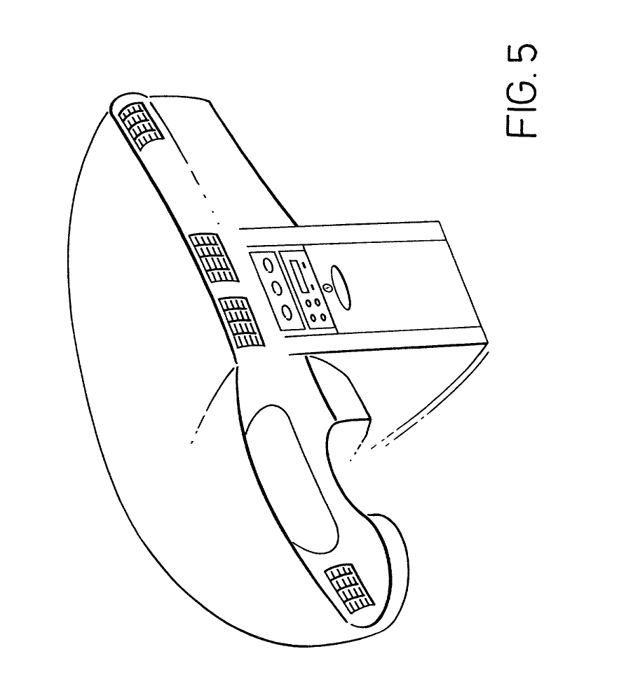

Referring to FIG. 3 a support rail device 126 is adapted to be secured to the rails 26 and that defines a generally rectangular aperture with inward projections for engaging a compact disc changer 127 having a power and audio lead connection 128. The compact disc changer 127 may be disposed in the support structure so as to be accessible to the open sides of the support structure so that the driver or the passenger can insert CD's as desired.

FIG. 3 also shows a tray 130 which is adapted to be secured to a support rail 26 at the top of the front and rear walls 121, 22 or 21, 22 and a second tray 131 which has a hinge 132 and a movable portion 133. The movable portion 133 may be hinged so as to lie against the main portion 131, thereby to be disposed within the storage structure in either the open or closed position for the storage structure, or alternatively may be hinged to the extended position. In the extended position, the movable portion 133 extends outwardly from the storage structure and may remain in that position when the storage structure is locked closed. It thereby provides a surface with engagement holes if needed for use when the main storage structure is closed.

FIG. 4 shows the disposition of the storage structure 20 between the passenger seat 40 and the driver's seat 41, shown cut away. In front of the driver's seat is the driver's footwell 10.

Referring to FIG. 5 the storage structure is shown in its closed position.

1. An open-sided storage structure for a motor vehicle cabin, the storage structure having opposing first and second end walls and runner members secured therebetween to define said open sides, said runner members being adapted to engage formations of the vehicle cabin whereby said structure is movable on said runner members between a first closed position and a second open position, said second open position allowing access by a vehicle passenger or driver.

2. The structure of claim 1, having plural securing devices, each securing device being adapted to secure thereto a support rail whereby said support rail extends from said first wall to said second wall, in combination with at least one said support rail and a storage insert for engaging the support rail, whereby said storage insert can be located in one of plural alternative dispositions.

3. The structure of claim 2 wherein the storage insert comprises a tray.

4. The structure of claim 3 wherein the tray has a cup holder portion.

5. The structure of claim 1, having plural securing devices, each securing device being adapted to secure thereto a support rail whereby said support rail extends from said first wall to said second wall, in combination with at least one said support rail and a compact disk changer for engaging the support rails whereby the compact disk changer may be located in one of plural alternative dispositions.

6. In combination, the structure of claim 1 wherein the first and second walls each have a respective top portion defining in part an opening therebetween, and wherein the first wall has an engagement formation at its top portion for a tray, and a said tray, the tray having a hinged portion movable from a first disposition in which it extends from the first wall towards the second wall, and a second disposition in which it extends outwardly from the first wall and away from the second wall.

7. A motor vehicle having a longitudinal axis and comprising a cabin having a driver's seat for accommodating a driver, the cabin having a front wall and an open-sided storage structure, said storage structure having a first wall, the first wall being disposed substantially transverse said axis and being secured to runner members extending substantially parallel to said axis, said runner members defining said open sides and engaging a formation of said cabin, wherein the first wall is translatable with said runner members along said longitudinal axis between a closed position where the first wall abuts a portion of said front cabin wall and an open position where the first end wall is spaced from said front cabin wall to allow access by said driver to said storage structure.

8. The motor vehicle of claim 7 wherein the storage structure has a second wall opposing the first wall, and plural securing devices, each securing device being adapted to secure thereto a support rail whereby said support rail extends from said first wall to said second wall, in combination with at least one said support rail and a storage insert for engaging the support rail, whereby said storage insert can be located in one of plural alternative dispositions.

9. The motor vehicle claim 8 wherein the storage insert comprises a tray.

10. The motor vehicle of claim 9 wherein the tray has a cup holder portion.

11. The motor vehicle of claim 7, wherein the storage structure has a second wall opposing the first wall, and plural securing devices, each securing device being adapted to secure thereto a support rail whereby said support rail extends from said first wall to said second wall, in combination with at least one said support rail and a compact disk changer for engaging the support rails whereby the compact disk changer may be located in one of plural alternative dispositions.

12. The motor vehicle of claim 7, wherein the storage structure has a second wall opposing the first wall, wherein the first and second walls of the storage structure each have a respective top portion defining in part an opening therebetween, and wherein the first wall has an engagement formation at its top portion for a tray, and further comprising a said tray, the tray having a hinged portion movable from a first disposition in which it extends from the first wall towards the second wall, and a second disposition in which it extends outwardly from the first wall and away from the second wall.

13. The motor vehicle of claim 12 wherein said storage structure may be moved to said closed position with said tray in said second disposition.

14. The motor vehicle of claim 7 having a lock for securing the storage structure in said closed position.

15. The motor vehicle of claim 7, wherein the cabin has a driver's foot well, and the storage structure is disposed in a housing having a outer wall forming a boundary of the foot well.

16. The motor vehicle of claim 15 wherein the housing extends to the floor of the vehicle.

17. The motor vehicle of claim 7 wherein said engagement of said runners and said formation of said cabin comprises rollers.
